(19) United States
(12) Patent Application Publication
(10) Pub. No.: US 2018/0001596 A1
(43) Pub. Date: Jan. 4, 2018

(54) ALUMINUM-ALLOY-CLAD PLATE AND ALUMINUM-ALLOY-CLAD STRUCTURAL MEMBER

(71) Applicant: Kabushiki Kaisha Kobe Seiko Sho (Kobe Steel, Ltd.), Kobe-shi (JP)

(72) Inventors: Katsushi MATSUMOTO, Kobe-shi (JP); Kazufumi SATO, Kobe-shi (JP)

(73) Assignee: Kabushiki Kaisha Kobe Seiko Sho (Kobe Steel, Ltd.), Kobe-shi (JP)

(21) Appl. No.: 15/546,696

(22) PCT Filed: Mar. 23, 2016
(86) PCT No.: PCT/JP2016/059275

§ 371 Date: Jul. 27, 2017

(30) Foreign Application Priority Data
Mar. 25, 2015 (JP) 2015-063100

(51) Int. Cl. B32B 15/01; C22C 21/10; C22C 21/06; C22F 1/04; B23K 20/02

(52) U.S. Cl. CPC B32B 15/016; C22C 21/10; C22C 21/06; B23K 20/02; C22F 1/04

(57) ABSTRACT

An aluminum-alloy-clad plate in which a plurality of aluminum alloy layers are layered and diffusion heat treatment is performed thereon, wherein aluminum alloy layers having a specific composition are layered so as to each have a different content Mg or Zn, the structure of the aluminum alloy clad plate after diffusion heat treatment thereof has a minute crystal grain diameter and a predetermined amount of a specific Mg and Zn inter-diffusion region in which Mg and Zn of layered aluminum alloy layers are diffused with each other, and increased strength and high moldability are obtained at the same time.

### TECHNICAL FIELD

The present invention relates to an aluminum alloy clad plate and an aluminum alloy clad structural member (hereinafter, aluminum is also referred to as Al). The clad plate is a laminate plate in which aluminum alloy layers are laminated together and are integrally bonded by rolling or the like.

### BACKGROUND ART

While an aluminum alloy plate is used as a material for weight saving in a structural member of a transport machine such as an automobile body or an airframe, high alloying for high strength tends to contradict formability into the structural member.

for example, 7000-series aluminum alloy or extra super duralumin (Al-5.5% Zn-2.5% Mg alloy) for the structural member contains an increased amount of strength-increasing element such as Zn or Mg as a typical method for high strength. This however reduces ductility and thus reduces the formability into the structural member. Furthermore, such high alloying causes deterioration in corrosion resistance or an increase in strength due to room-temperature aging (age hardening) during storage. This significantly deteriorates the formability into the structural member. In addition, this leads to low production efficiency of an alloy plate in a rolling step or the like.

Such a contradiction between high strength and formability is extremely difficult to be resolved only by a composition, a microstructure, or a manufacturing method of a simple aluminum alloy plate (single alloy plate) such as the 7000-series aluminum alloy plate and the extra super duralumin plate.

An aluminum alloy clad plate (laminate plate), in which two to four aluminum alloy layers (plains) having different compositions or properties are laminated together, has been known as a measure to solve this problem.

A typical example of such an aluminum alloy clad plate includes an aluminum-alloy brazing sheet for a heat exchanger, the aluminum-alloy brazing sheet having a three or four-layered structure in which a sacrificial anode material of 7000-series aluminum alloy and a 4000-series aluminum alloy brazing material are cladded on a 3000-series aluminum alloy core.

In addition, Patent Literature 1 provides an aluminum alloy material for a vehicle fuel tank, which includes a clad material including a core made of a 5000-series aluminum alloy material for high strength and a skin material made of a 7000-series aluminum alloy material for high corrosion resistance.

Patent Literature 2 provides a method of manufacturing a clad plate, in which differences in melting point between aluminum alloys such as 1000-series, 3000-series, 4000-series, 5000-series, 6000-series, and 7000-series are used to laminate at most four aluminum alloy layers together by continuous casting with a twin roll.

Patent Literature 3 suggests that when a plurality of aluminum alloy layers are laminated together, a Cu anti-corrosion layer is provided between such aluminum alloy layers, and Cu in the Cu anti-corrosion layer is diffused into the aluminum alloy layers bonded by high-temperature heat treatment to improve corrosion resistance of the clad plate.

### CITATION LIST

### Patent Literature

PTL1: Japanese Unexamined Patent Application Publication No. 2004-285391

PTL2: Japanese Patent No. 5083862

PTL3: Japanese Unexamined Patent Application Publication No. 2013-95880

### SUMMARY OF INVENTION

### Technical Problem

However, very few of such conventional aluminum alloy clad plates solve the contradiction between high strength and form ability as a material for the structural member of a transport machine. Hence, there is a technical problem to allow the aluminum alloy clad plate as a material for the structural member of a transport machine to have high strength and good formability.

To solve such a problem, an object of the present invention is to provide an aluminum alloy clad plate and an aluminum alloy clad structural member, which solve the contradiction between high strength and formability and have high strength and good formability.

### Solution to Problem

To achieve the object, an aluminum alloy clad plate of the present invention is summarized by

an aluminum alloy clad plate as a laminate of a plurality of aluminum alloy layers, in which each of the aluminum alloy layers laminated inside of an aluminum alloy layer on an outermost layer side of the aluminum alloy clad plate contains one or both of Mg: 3 to 10 mass % and Zn: 5 to 30 mass %,

the aluminum alloy layer on the outermost layer side has a composition containing Mg in a range from 3 to 10 mass % and Zn that is limited to 2 mass % or less including 0 mass %),

the aluminum alloy layers are laminated such that aluminum alloy layers having different contents of one of Mg and Zn are adjacently bonded to each other, the total number of laminated layers is 5 to 15, and the total thickness is 1 to 5 mm,

the aluminum alloy clad plate has an average content of Mg in a range from 2 to 8 mass % and an average content of Zn in a range from 3 to 20 mass %, the average content being an average of the contents of each of Mg and Zn of the laminated aluminum alloy layers, and

when the aluminum alloy clad plate is subjected to diffusion heat treatment, the aluminum alloy clad plate has a microstructure having an average grain size of 200 μm or less, the average grain size being an average of grain sizes of the laminated aluminum alloy layers, and having Mg—Zn inter diffusion regions, in each of which Mg and Zn interdiffuse between the laminated aluminum alloy layers, and

some of the Mg—Zn inter diffusion regions has respective concentrations of Mg and Zn in a range from 30 to 70% of the maximum contents of Mg and Zn of each of the aluminum alloy layers being not subjected to the diffusion heat treatment, and has a total thickness in a thickness direction that accounts for 40% or more of the thickness of the aluminum alloy clad plate.

To achieve the object, an aluminum alloy clad structural member of the present invention is summarized in that.

the structural member is produced by press-forming the above-described aluminum alloy clad plate,

the press-formed structural member is subjected to diffusion heat treatment and artificial aging, and thus has a microstructure having an average grain size of 200 μm or less, the average grain size being an average of grain sizes of the laminated aluminum alloy layers, and having Mg—Zn interdiffusion regions, in each of which Mg and Zn interdiffuse between the laminated aluminum alloy layers,

some of the Mg—Zn interdiffusion regions has respective concentrations of Mg and Zn in a range from 30 to 70% of the maximum contents of Mg and Zn of each of the aluminum alloy layers being not subjected to the diffusion heat treatment, and has a total thickness in the thickness direction that accounts for 40% or more of the thickness of the aluminum alloy clad plate, and

the structural member has a 0.2% proof stress of 400 MPa or more.

### Advantageous Effects of Invention

In the present invention, on the assumption of the above-described number of layers and plate thickness, the aluminum alloy layers to be cl added each have a specific composition containing a large amount of Mg and Zn in order to allow the aluminum alloy clad plate to have high strength and good formability. As a result, ductility of a material clad plate is increased to secure the press formability into the structural member. In this stage, the material clad plate is not necessary to be increased in strength because press formability is rather deteriorated.

After that, the material clad plate is press-formed into a structural member, and then Mg and Zn contained in the cladded aluminum alloy layers are diffused by the diffusion heat treatment between the microstructures of the laminated plates. Through such element diffusion, a new composite precipitate (age precipitate) including Mg, Zn, or Cu is precipitated at a bonding interface between the aluminum alloy layers to increase strength. In this respect, the specific composition, which contains a large amount of Mg or Zn, of each aluminum alloy layer to be cladded is not only defined from the viewpoint of ductility but also defined to allow the composite precipitate caused by the element diffusion to be precipitated at the bonding interface to achieve high strength.

In the present invention, it is assumed that the aluminum alloy clad structural member produced by forming of the aluminum alloy clad plate is subjected to diffusion heat treatment to increase strength through exertion of such an element diffusion mechanism.

The aluminum alloy clad structural member is subjected to the diffusion heat treatment, or subjected to the diffusion heat treatment and subsequent artificial aging (hereinafter, also referred to as T6 treatment), or subjected to the diffusion heat treatment, the subsequent artificial aging, and further subsequent artificial aging (age hardening) such as paint-bake treatment. Such an aluminum alloy clad structural member is increased in proof stress (strength) by the artificial aging, and has good bake hardenability (hereinafter, also referred to as BH property) being paint-hake hardenability or artificial age hardenability to have a required strength.

To secure high strength (BH property) through exertion of such an element diffusion mechanism, with a microstructure of the aluminum alloy clad plate (aluminum alloy clad structural member) subjected to the diffusion heat treatment or subjected to the diffusion heat treatment and subsequent artificial age hardening (T6 treatment), the Mg—Zn interdiffusion region of each aluminum alloy layer is defined by concentration distribution of Mg and Zn in the thickness direction.

Consequently, the present invention allows the aluminum alloy clad plate, which is subjected to the diffusion heat treatment and then used as the structural member, to have high strength and good formability.

### BRIEF DESCRIPTION OF DRAWINGS

FIG. 1 is a sectional view illustrating an embodiment of the clad plate of the present invention.

FIG. 2 is a sectional view illustrating another embodiment of the clad plate of the present invention.

FIG. 3 illustrates concentration distribution of Mg and Zn in a thickness direction of an aluminum alloy clad plate, which has been subjected to diffusion heat treatment, of Example (inventive example 1) of the present invention.

FIG. 4 illustrates concentration distribution of Mg and Zn in a thickness direction of an aluminum alloy clad plate, which has been subjected to diffusion heat treatment, of the Example (comparative example 14) of the present invention.

### DESCRIPTION OF EMBODIMENTS

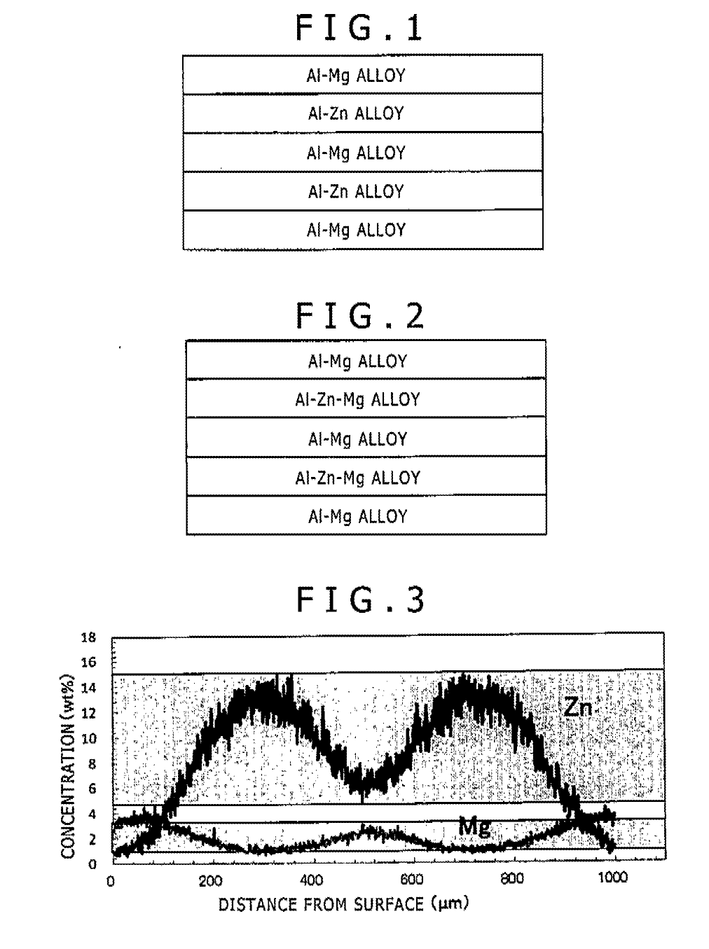

Best modes for carrying out. the aluminum alloy clad plate (hereinafter, also simply referred to as clad plate) and the aluminum alloy clad structural member (hereinafter, also simply referred to as clad structural member) of the present invention, the clad structural member being produced by forming of the clad plate used as a material, are now described with reference to FIGS. 1 and 2. FIGS. 1 and 2 each merely show a section of part of the clad plate of the present invention in a width or rolling (longitudinal) direction. Such a sectional structure extends evenly (uniformly) over the width or rolling direction of the entire clad plate of the present invention.

In the following description of one embodiment of the present invention, a plate before being cladded is referred to as aluminum alloy plate. When such aluminum alloy plates are cladded and thinned by rolling so as to be produced into a clad plate, a layer of the clad plate is referred to as aluminum alloy layer.

Hence, the meaning of definition, of a composition or a lamination way of the aluminum alloy layer of the clad plate may be considered as the same meaning of definition of that of an aluminum alloy plate or a slab before being cladded.

### Lamination Way of Clad Plate

In the clad plate of the present invention, 5 to 15 aluminum alloy layers (sheets) are laminated (cladded) together in such a manner that each aluminum alloy layer contains one or both of Mg and Zn in a defined range, and adjacent aluminum alloy layers have different contents of one of Mg and Zn, The aluminum alloy clad plate is relatively thin, i.e., the total thickness of the clad plate as a laminate is in a range from 1 to 5 mm.

In the clad plate of the present invention, a lamination way must be varied depending on compositions of the aluminum alloy layers to be combined for lamination. Such a lamination way is described with reference to FIGS. 1 and 2.

FIG. 1 shows an example, in which an Al—Mg alloy plate (aluminum alloy layer such as A in Table 1 as described later) is disposed as each of the aluminum alloy layers (two outermost layers) on the outermost layer side, an Al—Zn alloy plate (aluminum alloy layer such as D or E in Table 1 as described later) is laminated inside of each outermost layer, and an Al—Mg alloy plate (aluminum alloy layer such as A in Table 1 as described later) is disposed in the middle, i.e., the five layers in total are laminated together.

FIG. 2 also shows an example, in which an Al—Mg alloy plate (aluminum alloy layer such as A in Table 1 as described later) is disposed as each of the aluminum alloy layers (two outermost layers) on the outermost layer side, an Al—Zn—Mg alloy plate is laminated inside of each outermost layer, and an Al—Mg alloy plate (aluminum alloy layer such as A in Table 1 as described later) is disposed in the middle, i.e., the five layers in total are laminated together.

FIGS. 1 and 2 each show the example of the present invention, in which plates to be laminated to each other are aluminum alloy layers which each contain one or both of Mg and Zn in the defined content range, and have different contents of at least one of Mg and Zn.

Among such aluminum alloy layers to be combined, each of the Al—Zn aluminum alloy layer in FIG. 1 and the Al—Zn—Mg aluminum alloy layer in FIG. 2, which contains Zn in the defined content range, has a poor corrosion resistance, and is therefore laminated on an inner side of the clad plate to maintain corrosion resistance of the clad plate. If each of such aluminum alloy layers containing Zn is laminated on an outer side (surface side) of the clad plate, the clad plate and in turn the clad structural member are deteriorated in corrosion resistance because of the high Zn content.

In FIGS. 1 and 2, therefore, a clad plate containing Mg in the above-described content range (3 to 10 mass %). such as an Al—Mg system, is laminated as the aluminum alloy layer on each of the outermost layer sides (both outermost sides, both surface sides) of the clad plate. However, if such an Al—Mg system contains Zn or Cu in addition to Mg, corrosion resistance is also deteriorated. In the aluminum alloy layer, therefore, Zn must be limited to 2 mass % or less (including 0%) so that corrosion resistance is not significantly deteriorated.

As the number of layers to be laminated (the number of slabs or plates, the number of laminated layers as described later) is larger, the properties of the clad plate are more effectively exhibited, and at least five layers (sheets) are necessary to be laminated. For four layers or less, even if a lamination way is devised, a relatively thin aluminum alloy clad plate having a thickness in a range from 1 to 5 mm is not significantly different in properties from a simple plate (single plate), and thus there is no meaning in such lamination. On the other hand, when more than 15 layers (15 sheets) are laminated, the properties of the clad plate are promisingly more improved. This however is inefficient and impractical in light of productivity in an actual manufacturing process. Hence, at most about 15 layers should be laminated.

### Manufacturing Method of Clad Plate

There is described a method of manufacturing the clad plate of the present invention before being subjected to the diffusion heat treatment.

For a typical simple plate (single plate), if the 7000-series or the like is high-alloyed so as to contain Mg of at most 10 mass % or Zn of at most 30 mass % as in the present invention, ductility is extremely reduced and a rolling crack occurs, so that rolling cannot be performed. In contrast, in the present invention, since a laminate plate (laminate slab) includes thin plates that have different compositions, even if the laminate plate is high-alloyed as described above, ductility is high. Hence, the laminate plate can be hot-rolled and cold-rolled into a thin clad. That is, the clad plate of the present invention before being subjected to the diffusion heat treatment can be advantageously manufactured as a rolled clad plate by a typical rolling step.

Hence, 5 to 15 aluminum alloy slabs or plates, which each contain one or both of Mg and Zn in a defined range while having different contents of one of Mg and Zn, are laminated (cladded) before being rolled into a clad plate. As with a typical rolling step, such a laminate may be subjected to homogenization as necessary before being hot-rolled into a clad plate.

If the clad plate is further thinned in the above-described thickness range, the clad plate is further cold-rolled while being subjected to process annealing as necessary. The rolled clad plate is subjected to tempering (heat treatment such as annealing or solution treatment) to manufacture the clad plate of the present invention.

It is also allowable that the aluminum alloy slabs are separately subjected to homogenization, and then are laminated together and reheated to a hot-rolling temperature before being hot-rolled. Alternatively, the following process is also allowable: The aluminum alloy slabs are separately subjected to homogenization and then separately hot-rolled, and are separately subjected to process annealing or cold rolling as necessary so as to be separately produced into plates each having an appropriate thickness, and then the plates are laminated together into a plate material that is then cold-roiled into a clad plate.

The reason why the total thickness of the clad plate of the present invention is within a relatively small range from 1 to 5 mm is because the range corresponds to a thickness range generally used in the structural member of the transport machine. If the thickness is less than 1 mm, the clad plate does not meet the required properties such as stiffness, strength, workability, and weldability necessary for the structural member. If the thickness exceeds 5 mm, the clad plate is difficult to be press-formed into the structural member of the transport machine. In addition, lightweight, which is necessary for the structural member of the transport machine, is not achieved due to weight increase.

The thickness (plate thickness) of the slab is about 50 to 200 mm depending on the number of sheets (layers) to be laminated or on reductions so that the total thickness 1 to 5 mm of the final clad plate is achieved by the rolling clad method. When the total thickness of the final clad plate is 1 to 5 mm, thickness of each of the laminated alloy layers is about 0.05 to 2.0 mm (50 to 2000 μm) depending on the number of sheets (layers) to be laminated.

In another process, the individual plates are singly subjected to homogenization, hot rolling, and cold roiling as necessary, and then are laminated into a clad plate in a cold rolling step. In such a process, thickness of each plate material being laminated is about 0.5 to 5.0 mm depending on the number of sheets (layers) to be laminated or reductions.

### Aluminum Alloy

The composition of the aluminum alloy layer laminated inside the outermost layer of the clad plate before being subjected to the diffusion heat treatment (before being produced into the structural member) contains one or both of Mg: 3 to 10 mass % and Zn: 5 to 30 mass %. In other words, the aluminum alloy plate or slab before being cladded (laminated) or the cladded aluminum alloy layer has a composition containing one or both of Mg: 3 to 10mass % and 5 to 30 mass %.

The respective average contents of Mg and Zn of the entire aluminum alloy clad plate before being subjected to diffusion heat treatment (before being formed into the structural member) are in ranges of Mg: 2 to 8 mass % and Zn: 3 to 20 mass %, where the average contents are each an average of the contents of Mg or Zn of the laminated aluminum alloy layers.

The aluminum alloy layers (plates), which have the above-described composition while having different contents of at least one of Mg and Zn, are laminated to each other. In addition, the entire aluminum alloy clad plate contains Mg and Zn in the above-described respective content ranges. These are necessary for aluminum alloy clad plate to have formability and strength.

### Composition of Aluminum Alloy Layer Laminated Inside Outermost Layer

Such an aluminum alloy layer containing one or both of Mg: 3 to 10 mass % and Zn: 5 to 30 mass % may include a binary aluminum alloy such as an Al—Zn system and an Al—Mg system. The binary aluminum alloy may further contain at least one of selective additional elements Zn, Mg, Cu, Zr, and Ag. That is, the aluminum alloy layer may include a ternary system such as an Al—Zn—Mg system, an Al—Zn—Cu system, and an Al—Mg—Cu system, a quaternary system such as an Al—Zn—Cu—Zr system, and a quantic system such as an Al—Zn—Mg—Cu—Zr system.

A predetermined number of such aluminum alloy layers are combined and laminated together such that the aluminum alloy layers having different contents of one of Mg and Zn are adjacently bonded to each other, and the entire clad plate contains Mg, Zn, and at least one of the selective additional elements Cu, Zr, and Ag as necessary in the above-described respective average content ranges.

The reason why the elements as components of the aluminum alloy layers to be cladded or the clad plate are contained or limited is now individually described. In the case of the components of the clad plate, the content of each element is considered as an average of the contents of each element of plates (all plates) to be laminated instead of an average of the contents of each element of the aluminum alloy layers. In the following, the percentage representing the content refers to mass percent.

### Mg: 3 to 10%

Mg is an indispensable alloy element, and forms, with Zn, a cluster (fine precipitate) in the microstructure of the clad plate or the clad structural member, and thus improves work hardenability. In addition, Mg forms an age precipitate in the microstructure or a bonding interface of the clad plate or the clad structural member. The Mg content of less than 3% results in insufficient strength. The Mg content, of more than 10% causes a casting crack, and results in a deterioration in rolling performance of the clad plate (slab), making it difficult to manufacture the clad plate.

### Zn: 5 to 30%

Zn is an indispensable alloy element, and forms, with Mg, a cluster (fine precipitate) in the microstructure of the clad plate or the clad structural member, and thus improves work hardenability. In addition, Zn forms an age precipitate in the microstructure or the bonding interface of the clad plate or the clad structural member, and thus increases strength. The Zn content of less than 5% results in insufficient strength, and leads to imbalance between strength and form ability. If the Zn content exceeds 80%, a casting crack occurs, and rolling performance of the clad plate (slab) is deteriorated, making it difficult to manufacture the clad plate. Even if the clad plate can be manufactured, the amount of an intergranular precipitate MgZn₂ increases and thus intergranular corrosion easily occurs, leading to extreme deterioration in corrosion resistance and deterioration in formability.

### One or More of Cu, Zr, and Ag

Cu, Zr, and Ag are equieffective elements that each increase strength of the clad plate or the clad structural member while having differences in action mechanism therebetween, and are contained as necessary.

Cu exhibits the effect of increasing strength and an effect of improving corrosion resistance. A small content of Zr exhibits an effect of increasing strength through refining grains of the slab and the clad plate. A small content of Ag exhibits an effect of increasing strength through refining an age precipitate produced in the microstructure or the bonding interface of the clad plate or the clad structural member. However, if the content of each of Cu, Zr, and Ag is excessively large, manufacturing of the clad plate is difficult. Even if the clad plate can be manufactured, various problems occur, such as deterioration in corrosion resistance including stress corrosion cracking (SCC) resistance, and deterioration in ductility or a strength characteristic. Hence, when such elements are selectively contained, the contents are defined as follows: Cu: 0.5 to 5 mass %, Zr: 0.3 mass % or less (not including 0%), and Ag: 0.8 mass % or less (not including 0%).

### Other Elements:

Elements other than the described elements consist of inevitable impurities. Such impurity elements are assumed (allowed) to be contaminated due to use of aluminum alloy scraps as a melting material in addition to pure aluminum metal, and are thus allowed to be contained. Specifically, if the contents of the impurity elements are as follows: Fe: 0.5% or less, Si: 0.5% or less, Li: 0.1% or less, Mn: 0.5% or less, Cr: 0.3% or less, Sn: 0.1% or less, and Ti: 0.1% or less, ductility and a strength characteristic of the clad plate of the present invention are not deteriorated, and the impurity elements are allowed to be contained.

### Composition of Entire Clad Plate

The present invention, defines the composition of the aluminum alloy layer, and further defines the average contents of Mg and Zn as an average composition of the entire clad plate before the diffusion heat treatment.

The average contents of Mg and Zn of the entire clad plate are obtained in terms of weighted arithmetic means determined through assigning respective weights corresponding to the clad ratios to the contents of Mg and Zn of each of the laminated aluminum alloy layers. The average contents of Mg and Zn of the entire clad plate, which are each obtained as the weighted arithmetic mean, are defined to be Mg: 2 to 8 mass % and Zn: 3 to 20 mass %.

Specifically, the average composition of the entire clad plate is defined to contain one or both of Mg and Zn in the defined average content range, and selectively contain one or more of Cu, Zr, and Ag, the remainder consisting of aluminum and inevitable impurities.

The average content of Mg or Zn of the entire clad plate is determined in terms of a weighted arithmetic mean obtained through assigning a weight corresponding to a clad ratio of each aluminum alloy layer of the clad plate to the content of Mg or Zn of aluminum alloy configuring that aluminum alloy layer. In an example of the clad ratio, when a five-layered aluminum alloy clad plate includes aluminum alloy layers having the same thickness, any of the aluminum alloy layers has a clad ratio of 20%. The weighted arithmetic mean of the content of Mg or Zn is calculated using the clad ratio, and determined as the average content of Mg or Zn of the entire clad plate.

When each of the average contents of Mg and Zn as the average composition of the entire clad plate is excessively small to be less than the lower limit, Mg and Zn each insufficiently interdiffuse between the microstructures of the laminated plates subjected to the diffusion heat, treatment, of 500° C.×2 hr. As a result, such insufficient diffusion causes an insufficient amount of the new composite precipitate age precipitate) including Mg and Zn in the bonding interface between the plates. Hence, the total thickness in the thickness direction of the Mg—Zn interdiffusion region, in which concentration of each of Mg and Zn is within a range from 30 to 70%, becomes less than 40% of the thickness of the aluminum alloy clad plate, and thus the aluminum alloy clad plate cannot be increased in strength. Specifically, the aluminum alloy clad structural member, which is produced through the diffusion heat treatment and the artificial aging of the aluminum alloy clad plate, cannot, have a certain strength, or 0.2% proof stress of 400 MPa or more.

When the average content of each of Mg and Zn as the average composition of the entire clad plate is excessively large to exceed the upper limit, ductility of the clad plate is extremely reduced. Hence, press formability is reduced to a level, equivalent to a level of the 7000-series aluminum alloy plate, the extra super duralumin plate, a 2000-series aluminum alloy plate, or an 8000- series aluminum alloy plate for the structural member, and thus there is no meaning in such a clad plate.

The present invention intentionally provides an alternative to the aluminum alloy plate for the structural member, including 7000-series, extra super duralumin (Al-5.5% Zn-2.5% Mg alloy), 2000-series, and 8000-series. Specifically, the present invention mainly aims at greatly improving ductility of such a high-strength material in a stage of the clad plate as a forming material, and increasing strength of the formed structural member to a level similar to that of the existing high-strength material including a single plate by the diffusion heat treatment and the artificial aging. Hence, as the composition of the entire clad plate, a final composition of the clad plate must be equal or similar to a composition of the 7000-series aluminum alloy plate, the extra super duralumin plate, the 2000-series aluminum alloy plate, or the 8000-series aluminum alloy plate for the structural member.

From such a viewpoint, therefore, it is of significance that the composition of the clad, plate of the present invention is made similar to that of a single plate of the existing aluminum, alloy plate for the structural member, including 7000-series, extra super duralumin, 2000-series, and 8000-series. Specifically, it is of significance that, the clad plate contains one or both of Mg and Zn, which are major elements of the existing aluminum alloy plate, in ranges of Mg: 3 to 10 mass % and Zn: 5 to 30 mass %.

In this regard, the clad plate or the aluminum alloy layer of the present invention may contain Si and/or Li that are selectively contained in the composition of the existing aluminum alloy plate.

### Element Interdiffusion Microstructure of Clad Plate

In the present invention, the aluminum alloy clad plate, which is improved in formability by designing an alloy composition itself or a combination of alloy compositions as described above, is press-formed into the structural member as a use of the aluminum alloy clad plate, and then the structural member is subjected to the diffusion heat treatment to he increased in strength. Although the aluminum alloy clad plate can be barely formed into the structural member after being subjected to the diffusion heat treatment and increased in strength, forming is considerably difficult and requires a huge amount of effort.

Mg and Zn contained in the respective cladded aluminum alloy layers are allowed, to interdiffuse between the laminated (bonded) aluminum alloy layers by the diffusion beat treatment. Through such element inter diffusion, the new Zn—Mg fine composite precipitate (age precipitate) including Mg and Zn is densely precipitated in a bonding interface between the aluminum alloy layers so that interfacial microstructure control (ultrahigh-density dispersion of nano-level fine precipitates) is performed. Consequently, the clad plate (structural member) can be increased in strength after being subjected to the diffusion heat treatment and preferably further subjected to the artificial aging.

Hence, the element interdiffusion microstructure of the aluminum alloy clad plate of the present invention is a microstructure of the aluminum alloy clad plate subjected to the diffusion heat treatment as defined in claims of this application together with the average grain size of the aluminum alloy layer. Actually, the element interdiffusion microstructure is a microstructure of the structural member produced by forming of the aluminum alloy clad plate.

To allow the microstructure to be determined in a phase of a microstructure of the material aluminum alloy clad plate, the present invention defines the microstructure as an element interdiffusion microstructure (Mg—Zn interdiffusion region) or average grain size when the aluminum alloy clad plate is subjected to the diffusion heat, treatment.

Specifically, the present invention defines the Mg—Zn interdiffusion region and the average grain size when the aluminum alloy clad plate is subjected to the diffusion heat treatment as an experiment in a sense as described later in Example, so that the microstructure of the structural member can be determined and evaluated in a stage of the material aluminum alloy clad plate even if the diffusion heat treatment is not performed on the formed structural member.

It is prerequisite that the aluminium alloy layers to be laminated contain one or both of Mg and Zn in a defined range, and have different contents of at least one of Mg and Zn in order to allow Mg and Zn contained in the aluminium alloy layers to interdiffuse between adjacent laminated aluminium alloy layers.

Specifically, if the aluminium alloy layers have the same contents of Mg and Zn, Mg—Zn inter diffusion between the bonded layers does not occur even if the respective contents of other elements are different; hence, the new fine composite precipitate (age precipitate) including Mg and Zn cannot be densely precipitated in the bonding interface between the layers, so that high strength is not achieved.

The aluminium alloy layers to be cladded are defined to have the specific composition containing a large amount of Mg and/or Zn, and the aluminium alloy layers to be laminated and bonded to each other are defined to have different contents of at least one of Mg and Zn. Such definitions are not only made from the viewpoint of ductility, but also made to allow the composite precipitate caused by the element diffusion to be precipitated in the bonding interface between the layers by the diffusion heat treatment to achieve high strength.

### Mg—Zn Interdiffusion Region

In the present invention, to secure high strength through exertion of such a mechanism, when the aluminum alloy clad plate (or structural member) is subjected to the diffusion heat treatment or subjected to the diffusion heat treatment and subsequent artificial age hardening (T6 treatment), the aluminum alloy clad plate has a concentration distribution of Mg and Zn in the thickness direction, in which any of the laminated aluminum alloy layers has an average grain size of 200 μm or less as described later, and has the Mg—Zn interdiffusion regions, in each of which Mg and Zn interdiffuse between the laminated aluminum alloy layers.

Some of the Mg—Zn interdiffusion regions has respective concentrations of Mg and Zn in a range from 30 to 70% of the maximum contents of Mg and Zn (largest content of Mg or Zn maximum content) of each of the laminated aluminum alloy layers being not subjected to the diffusion heat treatment (being original), and has a total thickness in the thickness direction that accounts for 40% or more of the thickness of the aluminum alloy clad plate.

Such a degree of thickness (size) of the Mg—Zn interdiffusion regions subjected to the diffusion heat treatment is a criterion of the increase in strength caused by precipitation of the composite precipitate in the bonding interface due to the Mg—Zn interdiffusion, and reproducibly correlates with strength of the entire clad plate. Specifically, as the thickness (size) of the Mg—Zn interdiffusion region, subjected to the diffusion heat treatment is thicker (larger), the aluminum alloy clad plate (structural member) can be more increased in strength.

The total thickness in the thickness direction of the Mg—Zn interdiffusion regions, in each of which the concentration of each of Mg and Zn is in the range from 30 to 70%, varies depending on conditions of temperature and/or time of the diffusion heat treatment. It is therefore important to select the temperature and time of the diffusion heat treatment such that the total thickness in the thickness direction of the Mg—Zn interdiffusion regions each having the predetermined concentrations of Mg and Zn accounts for 40% or more of the thickness of the aluminum alloy clad plate.

Hence, to secure high strength through, exertion of such an element diffusion mechanism, with a microstructure of the aluminum alloy clad plate, the specific Mg—Zn interdiffusion region of the aluminum alloy clad plate subjected to the diffusion heat treatment is defined by concentration distribution of Mg and Zn in the thickness direction. Consequently, the present invention allows the aluminum alloy clad plate, which is subjected to the diffusion heat, treatment and then used as the structural member, to have high strength and good formability.

In this regard, when the total thickness in the thickness direction of the Mg—Zn interdiffusion regions, in each of which the respective concentrations of Mg and Zn are in a range from 30 to 70% of the maximum contents of Mg and Zn of the aluminum alloy layer being not subjected to the diffusion heat treatment, is less than 40% of the thickness of the aluminum alloy clad plate, a precipitated amount of the composite precipitate caused by the Mg—Zn interdiffusion is small in a bonding interface, and thus the aluminum alloy clad plate cannot be increased in strength.

Although the upper limit of the total thickness in the thickness direction of the Mg—Zn interdiffusion regions, in each of which the respective concentrations of Mg and Zn are in a range from 30 to 10% of the maximum contents of Mg and Zn of the aluminum alloy layer being not subjected to the diffusion heat treatment, is 100% or the thickness of the aluminum alloy clad plate, the upper limit is about 90% in light of the manufacturing limit (limit of the diffusion heat treatment) to allow Mg—Zn interdiffusion to occur.

Appropriately controlling the Mg—Zn interdiffusion regions promotes age hardening in such interdiffusion regions during the diffusion heat treatment and/or the artificial aging, and increases hardness in the regions. As a criterion of the hardness, increasing a proportion of a region having a high Vickers hardness of 120 Hv or more to the total thickness increases proof stress of a bulk.

### Average Grain Size

The structural member (or the clad plate), which is subjected to the diffusion heat, treatment, followed by the artificial age hardening (T6 treatment), is designed to include fine grains having an average grain size of 200 μm or less, the average grain size being an average of grain sizes (at the thickness center) of the laminated aluminum alloy layers. In other words, the grains are prevented from being coarsened even after the diffusion heat treatment.

Specifically, if the average grain size as an average of all grain sizes of the laminated aluminum alloy layers (at the thickness center) exceeds 200 μm, most of the grain sizes of the laminated aluminum alloy layers are so large as to exceed 200 μm.

As a result, when the aluminum alloy clad structural member is produced through performing the T6 treatment and paint baking on the clad plate including these laminated aluminum alloy layers, the aluminum alloy clad structural member cannot have the 0.2% proof stress of 400 MPa or more.

When the clad plate of the present invention or each of the aluminum alloy layers to he combined for lamination has a large thickness, the average grain size for one aluminum alloy layer less contributes to strength and formability. In the present invention, however, 5 to 15 aluminum alloy layers (sheets) are laminated (cladded) together, and the clad plate as a laminate is thin, i.e., has a total thickness of 1 to 5 mm; hence, the average grain size for one aluminum alloy layer significantly contributes to strength and formability.

### Diffusion Heat Treatment

As described above, the microstructure of the structural member (or clad plate) is designed to have the average grain size, which is an average of grain sizes of the laminated aluminum alloy layers, of 200 μm or less, and the Mg—Zn interdiffusion region having a thickness equal to or larger than the specific thickness to secure high strength. To achieve such a microstructure, the structural member or the clad plate must be subjected to the diffusion heat treatment under a preferred condition. In this regard, the structural member (or clad plate) is heated in a heat treatment furnace so as to be standardly subjected to the diffusion heat treatment under a condition selected from a condition range of holding for 0.1 to 24 hr at a temperature of 470 to 550° C.

It is, however, natural that Mg—Zn interdiffusion, which is caused by the diffusion heat treatment, between the aluminum alloy layers, or the average grain size after the diffusion heat treatment greatly varies depending on compositions, the number, or combinations of the aluminum alloy layers to be laminated.

Hence, the temperature is too low or the holding time is too short even within the above-described condition range depending on the condition of the aluminum alloy layers to be laminated, so that Mg—Zn interdiffusion between the aluminum alloy layers becomes insufficient, and thus the interdiffusion region becomes thin (small). As a result, high strength may not be achieved.

Conversely, the temperature or the holding time of the diffusion heat treatment is too high or too long even within the above-described condition range depending on the condition of the aluminum alloy layers to be laminated, so that grain sizes of the aluminum alloy layers increase and thus the average grain size cannot be adjusted to 200 μm or less. As a result, high strength may also not be achieved.

It is therefore necessary to determine (select) the optimum condition of temperature and time of the diffusion heat treatment for precise control depending on compositions, the number, or combinations of the aluminum alloy layers to be laminated as in the Example described later.

### Artificial Aging

The structural member (or clad plate) subjected to the diffusion heat treatment as described above is preferably subjected to artificial aging (artificial age hardening) so as to be further increased in strength.

With such an increase in strength, the present invention defines the strength after the artificial aging of 0.2% proof stress of 400 MPa or more as a criterion of the increase in strength of the aluminum alloy clad structural member produced by press-forming the clad plate.

Hence, the conditions of temperature and time of the artificial aging are determined based on desired strength, strength of the material clad plate, or a degree of progress of room-temperature aging before the artificial aging after manufacturing of the clad plate.

To exemplify a preferred condition of the artificial aging, one-step aging is performed for 12 to 36 hr at 100 to 150° C. (including an overaging region). For a two-step process, the condition (if the first step is selected from a condition range including heat treatment temperature of 70 to 100° C. and holding time of 2 hr or more, and the condition of the second step is selected from a condition range including heat treatment temperature of 100 to 170° C. and holding time of 5 hr or more (including an overaging region).

The Mg—Zn interdiffusion regions, the element interdiffusion microstructure, and the average grain size of the aluminum alloy layer, which are defined for the aluminum alloy clad plate or the structural member of the present invention, are each substantially not varied by the artificial aging within such a condition range. Consequently, the thickness of the Mg—Zn interdiffusion regions and the average grain size of the aluminum alloy layer, which are defined for the aluminum alloy clad plate or the structural member of the present invention, may be measured after the diffusion heat treatment or after the artificial aging following the diffusion heat treatment.

Furthermore, paint, baking of the clad structural member (or clad plate) may be performed within a typical condition range, and is performed for 20 to 30 min at 160 to 210° C.

### EXAMPLE

The present invention is now described in detail with Example.

A plurality of aluminum alloy layers were laminated and subjected to diffusion heat treatment, so that aluminum alloy clad plates having different Mg—Zn interdiffusion regions between the laminated aluminum alloy layers were manufactured, and formability and strength thereof were compared to one another. Table 2 shows the results.

The aluminum alloy clad plates were specifically manufactured as follows.

Aluminum alloy slabs A to K having alloy compositions shown in Table 1 were melted and casted. The casted slabs were separately subjected to homogenization, hot rolling, and cold rolling as necessary in the usual manner to produce plate materials that had the above-described compositions and were adjusted to have the same thickness of 1 mm such that all clad ratios were equal in correspondence to the number of laminated layers.

Such plate materials were laminated together in various combinations shown in Table 2. The laminated plate materials were reheated at 400° C. for 30 min, and were then produced into clad hot-rolled plates by a rolling clad method in which hot rolling was started at the reheating temperature.

Such clad hot-rolled plates were each cold-rolled while being further subjected to process annealing of 400° C.×1 sec, and were then subjected to heat treatment, in which the cold-rolled plats were heated at an average heating rate of 4° C./min and held for 2 hr at an achieving temperature of 400° C. and then cooled at a cooling rate of 20° C./sec, and were thus produced into clad plates each having a clad thickness (total thickness of the layers) shown in Table 2.

When the final clad plate had a total thickness of 1 to 5 mm, each of the laminated alloy plates roughly had a thickness in a range from 0.1 to 2.0 mm (100 to 2000 μm). The clad plate was manufactured such that thicknesses (clad ratios) of the aluminum alloy layers were equal to one another as described before.

The column of the aluminum alloy clad plate in Table 2 shows the average content of each of Mg and Zn in the entire aluminum alloy clad plate, the total laminated number of the plates in Table 1, and thickness, and further shows an assortment of the aluminum alloy layers (plates) A to K in Table 1 as a combination of the laminated plates in order from a top to a bottom of each laminate.

For example, some clad plates have 5, 11, and 13 odd layers that are laminated in order of ADADA, BEBEB, CFCFC, and the like. In each of the clad plates, the aluminum alloy layer A, B, or C in Table 1 is laminated on either outer side (either of the top and bottom sides) of the clad plate, and the aluminum alloy layer D, E, F, G, H or I in Table 1 is laminated on an inner side of the clad plate.

The content of each of Mg and Zn as the average composition of each aluminum alloy clad plate listed in Table 2 was calculated in terms of a weighted arithmetic mean assuming any clad aluminum alloy layer had an equal clad ratio corresponding to the number of laminated layers because the thicknesses of the aluminum alloy layers (plates) were even.

Elongations (%) of such manufactured clad plates were examined by a room-temperature tensile test described later. Table 2 shows the results.

Furthermore, the manufactured aluminum alloy clad plates were assumed (simulated) to be used as the structural members and subjected to diffusion heat treatment under conditions listed in Table 2, and then were in common held for one week at room temperature and then subjected to the artificial aging (T6treatment) of 120° C.×2 hr. Samples were taken from the aluminum alloy clad plates subjected to the T6 treatment.

The samples or the aluminum alloy clad plates subjected to the diffusion heat treatment were then subjected to a measurement of the average grain size at the thickness center of each of the laminated aluminum alloy layers, and a measurement of a proportion of the total thickness in the thickness direction of the Mg—Zn interdiffusion regions, in each of which Mg and Zn interdiffused between the laminated aluminum alloy layers.

The Mg—Zn interdiffusion region of each sample was determined as follows. Five samples were taken, from arbitrary five portions in a width direction of the clad plate. Respective concentrations of Mg and Zn in a thickness, direction for a section along the thickness direction of each sample were measured using an electron beam microanalyzer (EPMA).

The respective concentrations of Mg and Zn were measured every 1 μm in the thickness direction and used to determine presence of the Mg—Zn interdiffusion region, in which the respective concentrations were within a range from 30 to 70% of the maximum contents of Mg and Zn of each of the aluminum alloy layers being not subjected to the diffusion heat treatment. The total thickness in the thickness direction of such interdiffusion regions was obtained, and a ratio (%) of the total thickness to the thickness of the aluminum alloy clad plate was calculated. After that, the ratios for the five measured samples were averaged as a ratio (%) of the total thickness in the thickness direction of the Mg—Zn interdiffusion regions to the thickness of the aluminum alloy clad plate.

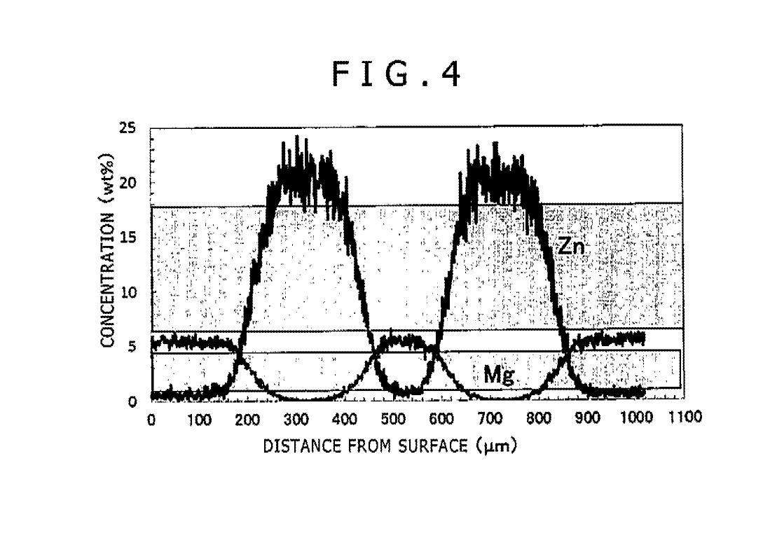

FIGS. 3 and 4 each illustrate the measured concentration distributions in the thickness direction of Mg and Zn in the aluminum alloy clad plate subjected to the diffusion heat treatment.

FIG. 3 shows the inventive example 1 (ADADA) in Table 2 in a combination of the aluminum alloy layers A and D in Table 1 as a combination of the pattern of FIG. 1. FIG. 4 shows the comparative example 14 (BFBFB) in Table 2 in a combination of the aluminum alloy layers B and F in Table 1 as a combination of the pattern of FIG. 1.

In FIGS. 3 and 4 the horizontal axis shows positions in the thickness direction in a range from 0 to 1000 μm (thickness 1 mm), or from the surface (0 μm) to the back (1000 μm) of the clad plate. The vertical axis shows respective concentrations (contents, mass %) of Mg and Zn.

In FIGS. 3 and 4, a region having a highest Mg concentration shows a region of the aluminum alloy layer A or B being original (being not subjected to the diffusion heat treatment). A region having a highest Zn concentration shows a region of the aluminum alloy layer D or F being original (being not subjected to the diffusion heat treatment). Other regions each having a concentration gradient of Mg or Zn are Mg—Zn interdiffusion regions.

Hence, the Mg—Zn interdiffusion region, in which the respective concentrations of Mg and Zn are within a range from 30 to 70% of the maximum contents of Mg and Zn of the aluminum alloy layer being original, or being not subjected to the diffusion heat treatment, includes not only the thickness of the Mg—Zn interdiffusion region having a gradient, of the concentration of each of Mg and Zn, but also the thickness of the original aluminum alloy layer, in which the content of each of Mg and Zn of the original aluminum, alloy layer is decreased by the diffusion.

In FIGS. 3 and 4, the respective maximum contents of Mg and Zn of the aluminum alloy layer being not subjected to the diffusion heat treatment (being original) are the Mg content 5.0 mass % of the aluminum alloy layer A or B in Table 1 and the Zn content 20.0 mass % of the aluminum alloy layer D or F in Table 1.

The average grain size of the laminated aluminum alloy layers of each sample subjected to the T6 treatment was measured. Specifically, first, the concentration distribution of each of Mg and Zn was measured for a section at the thickness center of any of the laminated aluminum alloy layers, and grain size was measured at each of five visual fields in that section through observation by a light microscope of 100 magnifications. Average grain size at the thickness center of each aluminum alloy layer was obtained from such measurement, results. Such average grain sizes at the thickness center of the aluminum alloy layers were averaged for all the laminated aluminum alloy layers, and the resultant value was determined as “average grain size as the average of the grain sizes of the laminated aluminum alloy layers” (μm) defined in claim 1. Table 2 shows the results.

Furthermore, as shown in Table 2, 0.2% proof stress (MPa) of the aluminum alloy clad plate subjected to the T6 treatment was also examined. Table 2 also shows the results.

In each of the examples, the sample was machined into a JIS No. 5 test specimen, and the test specimen was subjected to a room-temperature tensile test, in which a tensile direction was parallel to a rolling direction, and 0.2% proof stress (MPa) was measured. The room-temperature tensile test was performed in accordance with JIS 2241 (1980) at, a room temperature of 20° C., with a gage length of 50 mm, and at a constant tensile speed of 5mm/min until the test specimen was broken. The total elongation (%) of the manufactured clad plate (being not subjected to the T6 treatment) was also measured in the same manner.

For reference, hardness distribution (Hv) in the thickness direction on a section of the clad plate was examined for a sample subjected to the T6 treatment. Hardness in the thickness direction on a section of the clad plate was sequentially measured with a dense indentation interval by a commercially available micro-Vickers hardness tester, and a proportion in the thickness direction of regions having a Vickers hardness of 120 Hv or more (proportion of the total length of indentations showing 120 Hv or more to the plate thickness: %) was calculated. A micro-Vickers measurement was performed at a load of 10 g.

In inventive examples 1 to 12 in Table 2, the laminated aluminum alloy layers each have a defined alloy composition as a composition before the diffusion heat treatment, and the average content of each of Mg and Zn of the aluminum alloy clad plate is also within the defined range. The aluminum alloy layer D, E, F, G, H, or I containing Zn in the defined content range is laminated on an inner side of the clad plate, and the aluminum alloy layer A, B, or C on each outermost layer side contains Mg in a range from 3 to 10 mass % and Zn that is limited to 2 mass % or less (including 0 mass %).

Such aluminum alloy layers are laminated by the defined total number 5 to 13 of layers so as to have a total thickness within the defined range such that aluminum alloy layers having different contents of Mg or Zn are adjacently bonded to each other.

The aluminum alloy clad plate subjected to the diffusion heat treatment under an appropriate condition has an average grain size of 200 μm or less for each of the laminated aluminum alloy layers, and has the Mg—Zn interdiffusion regions.

Furthermore, some of the Mg—Zn interdiffusion regions, in which the respective concentrations of Mg and Zn are within a range from 80 to 70% of the maximum contents of Mg and Zn of the aluminum alloy layer being not subjected to the diffusion heat treatment, has a total thickness in the thickness direction that accounts for 40% or more of the thickness of the aluminum alloy clad plate.

As a result, for each of the clad plates of the inventive examples, a total elongation of the manufactured clad plate (being not subjected to the T6 treatment) is 17% or more, showing good formability. In addition, when such an aluminum clad plate is subjected to the diffusion heat treatment, the room-temperature aging, and the artificial aging, which are collectively assumed to he heat treatment on the press-formed structural member, the aluminum clad plate shows high strength, i.e., 0.2% proof stress of 400 MPa or more. This fact is also supported by a large proportion of the region showing a Vickers hardness in the thickness direction of 120 Hv or more in the hardness distribution (Hv) in the thickness direction on the section of the clad plate.

On the other hand, each of she comparative examples 13 to 21 in Table 2 does not sanely the requirements defined in the present invention, in which although the elongation of the manufactured clad plate is similar to that of one of the inventive examples, 0.2% proof stress after the diffusion heat treatment, the room-temperature aging, and the artificial aging is extremely low less than 350 MPa. This fact is also supported by a small proportion, compared with each inventive example, in the thickness direction of the region showing a Vickers hardness of 120 Hv or more in the hardness distribution (Hv) in the thickness direction on the section of the clad plate.

In the comparative example 13, although a combination of the aluminum alloy layers to be laminated is the same as that of some of the inventive examples, the number of the laminated layers ADA is as small as three. Hence, although the diffusion heat treatment is performed under the same condition as that of some of the inventive examples, the average grain size of the laminated aluminum alloy layers is so large as to exceed 200 μm, and the total thickness in the thickness direction of the Mg—Zn interdiffusion regions is only less than 40% of the thickness of the aluminum alloy clad plate.

In each of the comparative examples 14 to 19, although a combination of the aluminum alloy layers to be laminated is the same as that of some of the inventive examples, the diffusion heat treatment is not performed under the optimum condition (temperature, holding time) corresponding to the condition la composition, the number of laminated layers, a combination of layers to be laminated) of the aluminum alloy layers.

Hence, the total thickness in the thickness direction of the Mg—Zn interdiffusion regions is only less than 40% of the thickness of the aluminum alloy clad plate.

In the comparative example 20, each of the aluminum alloy layers to be laminated has a composition including J or K out of the defined range in Table 1, and thus has extremely small contents of Mg and Zn, and the average composition also has extremely small contents of Mg and Zn.

Hence, the total thickness in the thickness direction of the Mg—Zn interdiffusion regions is only less than 40% of the thickness of the aluminum alloy clad plate.

In the comparative example 21, each of the aluminum alloy layers to be laminated has a composition including K out of the defined range in Table 1, and thus has an extremely small content of Zn, and the average composition also has an extremely small content of Zn.

Hence, the total thickness in the thickness direction of the Mg—Zn. interdiffusion regions is only less than 40% of the thickness of the aluminum alloy clad plate.

TABLE 1

| | | Composition of aluminum alloy layer to be laminated | | | | | | | |
|---|---|---|---|---|---|---|---|---|---|
| | | (mass %, the remainder: Al) | | | | | | | |
| Symbol | Alloy system | Mg | Zn | Cu | Si | Fe | Zr | Ag | Ti |
| A | Al—Mg binary | 5.0 | — | — | — | — | — | — | — |
| B | Al—Mg binary | 5.0 | — | — | 0.1 | 0.1 | 0.06 | — | 0.01 |
| C | Al—Mg binary | 8.0 | — | — | 0.05 | 0.1 | 0.06 | — | 0.01 |
| D | Al—Zn binary | — | 20.0 | — | — | — | — | — | — |
| E | Al—Zn binary | — | 10.0 | 2.0 | 0.05 | 0.05 | 0.08 | — | 0.01 |
| F | Al—Zn binary | — | 20.0 | 1.0 | 0.2 | 0.1 | 0.08 | — | 0.01 |
| G | Al—Zn binary | — | 20.0 | 3.0 | 0.2 | 0.1 | 0.08 | — | 0.01 |
| H | Al—Zn binary | — | 20.0 | 1.0 | 0.2 | 0.1 | 0.08 | 0.7 | 0.01 |
| I | Al—Zn binary | — | 30.0 | — | 0.1 | 0.15 | 0.08 | — | 0.01 |
| J | Al—Mg binary | 2.0 | — | — | 0.1 | 0.1 | — | — | 0.01 |
| K | Al—Zn binary | — | 4.0 | 0.2 | 0.1 | 0.1 | — | — | 0.01 |

A sign “—” in Table indicates that the content of the element is equal to or lower than the detection limit, or is substantially 0 mass %.

TABLE 2

| | | Aluminum alloy clad plate | | | | | |
|---|---|---|---|---|---|---|---|
| | | | | Combination of | Average composition | | |
| | | Number of laminated | | plates in Table 1 | (mass %) | | Total |
| | | aluminum alloy | Thickness | (lamination order: | Mg | Zn | elongation |
| Classification | No. | layers (layer) | (mm) | top to bottom) | content | content | (%) |
| Inventive | 1 | 5 | 1.0 | ADADA | 3 | 8 | 17 |
| example | 2 | 11 | 1.0 | ADADADADADA | 2.73 | 9.1 | 17 |
| | 3 | 13 | 1.0 | ADADADADADADA | 2.69 | 9.23 | 23 |
| | 4 | 5 | 1.0 | CFCFC | 4.8 | 8 | 17 |
| | 5 | 5 | 1.0 | BEBEB | 3 | 4 | 22 |
| | 6 | 5 | 1.0 | BFBFB | 3 | 8 | 18 |
| | 7 | 13 | 1.0 | BFBFBFBFBFBFB | 2.69 | 9.23 | 19 |
| | 8 | 11 | 1.0 | BGBGBGBGBGB | 2.73 | 9.1 | 17 |
| | 9 | 5 | 1.0 | BHBHB | 3 | 8 | 19 |
| | 10 | 11 | 2.0 | BHBHBHBHBHB | 2.73 | 9.1 | 18 |
| | 11 | 13 | 5.0 | BHBHBHBHBHBHB | 2.69 | 9.23 | 18 |
| | 12 | 5 | 1.0 | BIBIB | 3 | 12 | 20 |
| Comparative | 13 | 3 | 1.0 | ADA | 3.33 | 6.67 | 17 |
| example | 14 | 5 | 2.0 | BFBFB | 3 | 8 | 18 |
| | 15 | 11 | 2.0 | BFBFBFBFBFB | 2.73 | 9.1 | 19 |
| | 16 | 13 | 5.0 | BFBFBFBFBFBFB | 2.69 | 9.23 | 19 |
| | 17 | 5 | 1.0 | BHBHB | 3 | 8 | 18 |
| | 18 | 11 | 1.0 | BHBHBHBHBHB | 2.73 | 9.1 | 19 |
| | 19 | 13 | 1.0 | BHBHBHBHBHBHB | 2.69 | 9.23 | 19 |
| | 20 | 5 | 2.0 | JKJKJ | 1.2 | 1.6 | 26 |
| | 21 | 5 | 1.0 | BKBKB | 3 | 1.6 | 29 |

| | | Aluminum alloy clad plate after T6 treatment | | | | |
|---|---|---|---|---|---|---|
| | | | | Concentration | Hardness | |
| | | | | distribution in | distribution in | |
| | | | | thickness direction | thickness direction | |
| | | | Aluminum | Proportion (%) of | Proportion (%) in | Strength |
| | | Diffusion heat | alloy layer | total thickness in | thickness direction | 0.2% |
| | | treatment condition | Average | thickness direction | of region having | Proof |
| | | Temperature × | grain size | of Mg—Zn | Vickers hardness of | stress |
| Classification | No. | holding time | (μm) | interdiffusion regions | 120 Hv or more | (MPa) |
| Inventive | 1 | 500° C. × 2 hr | 192 | 57 | 48 | 408 |
| example | 2 | 510° C. × 0.5 hr | 182 | 65 | 62 | 440 |
| | 3 | 520° C. × 0.2 hr | 168 | 64 | 60 | 462 |
| | 4 | 500° C. × 2 hr | 184 | 58 | 57 | 437 |
| | 5 | 460° C. × 8 hr | 162 | 76 | 64 | 400 |
| | 6 | 500° C. × 4 hr | 178 | 69 | 67 | 420 |
| | 7 | 500° C. × 1 hr | 132 | 89 | 85 | 512 |
| | 8 | 470° C. × 4 hr | 146 | 75 | 74 | 401 |
| | 9 | 500° C. × 2 hr | 174 | 66 | 63 | 428 |
| | 10 | 500° C. × 4 hr | 184 | 83 | 78 | 465 |
| | 11 | 490° C. × 24 hr | 196 | 84 | 79 | 474 |
| | 12 | 480° C. × 2 hr | 150 | 45 | 46 | 409 |
| Comparative | 13 | 500° C. × 2 hr | 242 | 21 | 19 | 221 |
| example | 14 | 500° C. × 2 hr | 188 | 28 | 25 | 324 |
| | 15 | 500° C. × 0.8 hr | 156 | 29 | 24 | 281 |
| | 16 | 500° C. × 0.5 hr | 142 | 18 | 17 | 209 |
| | 17 | 440° C. × 4 hr | 124 | 26 | 19 | 194 |
| | 18 | 440° C. × 2 hr | 128 | 21 | 17 | 185 |
| | 19 | 450° C. × 3 hr | 146 | 29 | 18 | 188 |
| | 20 | 500° C. × 1 hr | 186 | 28 | 3 | 141 |
| | 21 | 450° C. × 0.5 hr | 176 | 20 | 7 | 129 |

The Example supports the meaning of the requirements of the present invention to achieve the aluminum alloy clad plate having high strength and good formability.

Although the present invention has been described in detail with reference to one specific embodiment, it should be understood by those skilled in the art that various alterations and modifications thereof may be made without departing from the spirit and the scope of the present invention.

The present application is based on Japanese patent application (JP-2015-083100) filed on Mar. 25, 2015, the content of which is hereby incorporated by reference.

### INDUSTRIAL APPLICABILITY

According to the present invention, it is possible to provide an aluminum alloy clad plate that resolves the contradiction between a high strength level and formability in a single plate of the existing 7000-series aluminum alloy or the like, and provide an aluminum alloy clad plate having high strength and good formability or a structural member, which is produced by forming of the clad plate, for a transport machine.

1. An aluminum alloy clad plate as a laminate of a plurality of aluminum alloy layers,
wherein each of the aluminum alloy layers laminated inside of an aluminum alloy layer on an outermost layer side of the aluminum alloy clad plate contains one or both of Mg: 3 to 10 mass % and Zn: 5 to 30 mass %,
the aluminum alloy layer on the outermost layer side has a composition containing Mg in a range from 3 to 10 mass % and Zn that is limited to 2 mass % or less (including 0 mass %),
the aluminum alloy layers are laminated such that aluminum alloy layers having different contents of one of Mg and Zn are adjacently bonded to each other, the total number of laminated layers is 5 to 15, and total thickness is 1 to 5 mm,
the aluminum alloy clad plate has an average content of Mg in a range from 2 to 8 mass % and an average content of Zn in a range from 3 to 20 mass %; the average content being an average of the contents of each of Mg and Zn of the laminated aluminum alloy layers,
when the aluminum alloy clad plate is subjected to diffusion heat treatment, the aluminum alloy clad plate has a microstructure having an average grain size of 200 μm or less, the average grain size being an average of grain sizes of the laminated aluminum alloy layers, and having Mg—Zn interdiffusion regions each containing Mg and Zn that interdiffuse between the laminated aluminum alloy layers, and
some of the Mg—Zn interdiffusion regions has respective concentrations of Mg and Zn in a range from 30 to 70% of the maximum contents of Mg and Zn of each of the aluminum alloy layers being not subjected to the diffusion heat treatment, and has a total thickness in a thickness direction that accounts for 40% or more of the thickness of the aluminum alloy clad plate.

2. An aluminum alloy clad structural member produced by press-forming the aluminum alloy clad plate according to claim 1,
wherein the press-formed structural member is subjected to diffusion heat treatment and artificial aging, and thus has a microstructure having an average grain size of 200 μm or less, the average grain size being an average of grain sizes of the laminated aluminum alloy layers, and having Mg—Zn interdiffusion regions each containing Mg and Zn that interdiffuse between the laminated aluminum alloy layers,
some of the Mg—Zn interdiffusion regions has respective concentrations of Mg and Zn in a range from 30 to 70% of the maximum contents of Mg and Zn of each of the aluminum alloy layers being not subjected to the diffusion heat treatment, and has a total thickness in the thickness direction that accounts for 40% or more of the thickness of the aluminum alloy clad plate, and
the structural member has a 0.2% proof stress of 400 MPa or more.
